(19) United States
(12) Patent Application Publication
(10) Pub. No.: US 2018/0283163 A1
(43) Pub. Date: Oct. 4, 2018

(54) SUBSEA PUMP SYSTEM

(71) Applicants: AKER SOLUTIONS INC., HOUSTON, TX (US); BAKER HUGHES, A GE COMPANY, LLC, HOUSTON, TX (US)

(72) Inventors: ROBIN SLATER, ELLON (GB); WILLIAM JOHNSTON, HOUSTON, TX (US); IAN MITCHELL, RICHMOND, TX (US); ALEXANDER BARRY, CYPRESS, TX (US)

(73) Assignees: AKER SOLUTIONS INC., HOUSTON, TX (US); BAKER HUGHES, A GE COMPANY, LLC, HOUSTON, TX (US)

(21) Appl. No.: 15/761,813

(22) PCT Filed: Sep. 22, 2016
(86) PCT No.: PCT/NO2016/050193

§ 371 Date: Mar. 21, 2018

Related U.S. Application Data
(60) Provisional application No. 62/222,297, filed on Sep. 23, 2015.

(51) Int. Cl. E21B 47/00; E21B 43/12; E21B 43/36; F04D 13/08; F04B 23/02; G01L 11/02; G01K 11/32; H02K 5/132; H02K 7/14; H02K 11/22

(52) U.S. Cl. CPC E21B 47/0001; E21B 43/126; E21B 43/36; F04D 13/086; H02K 11/22; G01L 11/025; G01K 11/3206; H02K 5/132; H02K 7/14; F04B 23/02

(57) ABSTRACT

A subsea pump system includes a subsea pump, a fluid conditioner tank arranged upstream of the subsea pump, a liquid conservation tank arranged downstream of the subsea pump, a line arranged to recirculate a liquid from the liquid conservation tank to upstream of the subsea pump, an umbilical which provides power, a monitoring and a control, a first buoyancy element suspended in the fluid conditioner tank, a second buoyancy element suspended in the liquid conservation tank, optical fiber sensors which are arranged at least to a suspension of the first buoyancy element in the fluid conditioner tank and to a suspension of the second buoyancy element in the liquid conservation tank, and electronics.

### CROSS REFERENCE TO PRIOR APPLICATIONS

This application is a U.S. National Phase application under 35 U.S.C. § 371 of International Application No. PCT/NO2016/050193, filed on Sep. 22, 2016 and which claims benefit to U.S. Provisional Patent Application No. 62/222,297, filed on Sep. 23, 2015. The International Application was published in English on Mar. 30, 2017 as WO 2017/052383 A1 under PCT Article 21(2).

### FIELD

The present invention relates to subsea pumps for the petroleum industry, and to the instrumentation, control, reliability and cost thereof.

### BACKGROUND

Reliability is a key issue for subsea equipment.

A subsea pump system, i.e., a pump system which is arranged on or at the seabed for pumping a multiphase fluid or a one phase fluid, typically comprises electronic instrumentation and electronic control modules arranged subsea. Subsea electronics can be a limitation with respect to reliability since a large number of components and connections are included. Even though each component has a very high reliability, the reliability of each component typically must be multiplied with the reliability of other components. Because thousands of components are sometimes used, the resulting reliability can limit the uptime of the equipment.

Smart Fibres Ltd. of the United Kingdom has suggested a subsea pump with a condition monitoring system having fiber optical sensors (http://smartfibres.com/docs/Subsea_Rotating_Machine_Condition_Monitoring_System.pdf).

Smart Fibres describes that optical Fiber Bragg Grating (FBG) technology is used for condition monitoring of a subsea pump and motor by arranging optical fibers with FBG sensors to the subsea motor and pump. All optical sensors are suggested subsea, with electronic instrumentation at the surface, connected via optical fibers in an umbilical. Only FBG sensors are suggested and only as arranged to the subsea pump and motor.

For a downhole pump, a so-called electric submersible pump (ESP), US 2015/0110439 A1 describes and illustrates distributed fiber optic sensing devices for monitoring the health of an ESP downhole. The method and system described relate to determining a parameter of at least one component of an artificial lift system located in a subterranean formation. It is not explicitly described where processors and electronic modules are arranged; topsides or down hole. Is not clear from US 2015/0110439 A1 whether components or parameters in addition to the at least one parameter and component are monitored with electronic sensors or optical fiber sensors, downhole or topsides, or where the electronics are arranged.

### SUMMARY

An aspect of the present invention is to provide improved reliability and reduced cost for subsea pumps and subsea pump systems.

In an embodiment, the present invention provides a subsea pump system which includes a subsea pump, a fluid conditioner tank arranged upstream of the subsea pump, a liquid conservation tank arranged downstream of the subsea pump, a line arranged to recirculate a liquid from the liquid conservation tank to upstream of the subsea pump, an umbilical configured to provide a power, a monitoring and a control, a first buoyancy element suspended in the fluid conditioner tank, a second buoyancy element suspended in the liquid conservation tank, optical fiber sensors which are arranged at least to a suspension of the first buoyancy element in the fluid conditioner tank and to a suspension of the second buoyancy element in the liquid conservation tank, and electronics.

### BRIEF DESCRIPTION OF THE DRAWINGS

The present invention is described in greater detail below on the basis of embodiments and of the drawings in which:

FIG. 1 shows an embodiment of a subsea pump system of the present invention; and

FIG. 2 shows details of the subsea pump system.

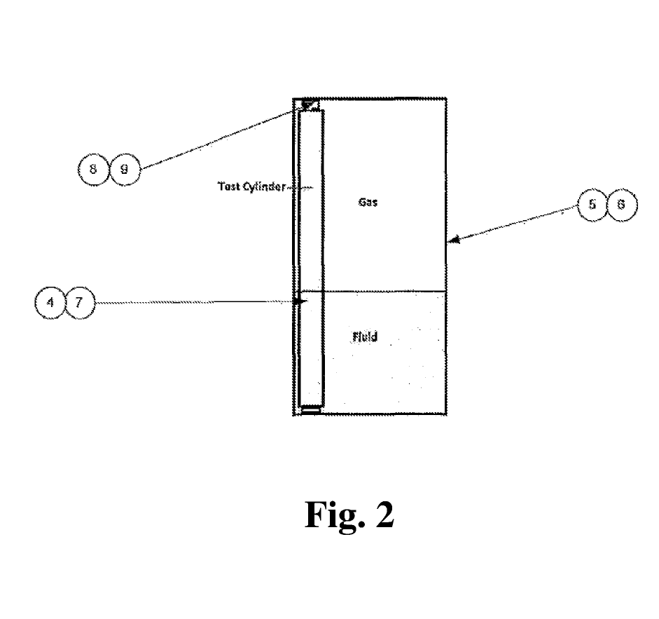

### DETAILED DESCRIPTION

In an embodiment, the present invention provides a subsea pump system, comprising:

a subsea pump;

a fluid conditioner tank;

a liquid conservation tank;

a line arranged for liquid recirculation from the liquid conservation tank to upstream of the subsea pump; and

an umbilical for power, monitoring and control,

wherein, the fluid conditioner tank is arranged upstream to the subsea pump which is arranged upstream to the liquid conservation tank.

The subsea pump system is distinctive by that it further comprises:

a first buoyancy element suspended in the fluid conditioner tank;

a second buoyancy element suspended in the liquid conservation tank;

optical fiber sensors, at least arranged to a suspension of the buoyancy element in the fluid conditioner tank and to a suspension of the buoyancy element in the liquid conservation tank; and

electronics,

wherein, all subsea sensors can, for example, consist of optical fiber sensors and all electronics for monitoring and control can, for example, consist of electronics arranged topsides.

In an embodiment of the present invention, all subsea sensors can, for example, consist of optical fiber sensors and all electronics for monitoring and control can, for example, consist of electronics arranged topsides. Topsides means above the water, on a platform or vessel or onshore. No electronics can, for example, be arranged subsea, especially no electronics for monitoring and control. A possible exception, not for monitoring and control, however, and definitely not in contact with process fluids or subsea pump motor compartment fluids, is a possible subsea electronics module, conveniently arranged at the subsea umbilical termination, for analog to digital conversion of optical signals, for allowing longer distance transmission. Such a subsea electronics module, if present, is, however, not for monitoring and control, but only for conversion of one type of optical signals to another type of optical signals for better transmission of the optical signals. No electronics is accordingly operatively coupled to the process equipment for monitoring and control.

The subsea pump system can, for example, comprise a single wet mate connector connecting the umbilical to the subsea pump and the optical fiber sensors of the subsea pump, the fluid conditioner tank and the liquid conservation tank. All other connections can, for example, be by dry mate connectors or pre-installed fusion splices made before the subsea pump system installation.

In an embodiment of the present invention, the subsea pump system can, for example, comprise fiber optical sensors in the umbilical for measuring both temperature and a strain of a dynamic loading of the umbilical.

In an embodiment of the present invention, the subsea pump system can, for example, comprise at least one Fabry Perot optical fiber pressure and temperature sensor.

In an embodiment of the present invention, the subsea pump system can, for example, comprise fiber optic sensors for liquid level monitoring using differential pressure in the fluid conditioner tank and the liquid conservation tank. In an embodiment of the present invention, the subsea pump system can, for example, comprise fiber optic Bragg grating sensor arrays attached to the suspension of the buoyancy element in the fluid conditioner tank and to the suspension of the buoyancy element in the liquid conservation tank. The buoyancy elements used in the system of the present invention may have positive or negative buoyancy as submerged in liquid, however, the elements must have a known weight and volume or the measured values must be calibrated to values of at least one of the parameters: level, flow rate, and fluid composition.

The subsea pump system can, for example, comprise one or more of fiber optic Bragg grating or Distributed Acoustic Sensing, as optical fibers, operatively arranged to the subsea equipment structure or subsea rotating equipment. The pump system of the present invention can, for example, also comprise fiber optical Distributed Temperature Sensing (DTS), particularly as arranged in the process fluid flow path or volumes and downstream of a bypass choke, which is particularly useful for detecting a risk of hydrate formation during shut-in or bypass choking. The subsea pump system can, for example, also comprise fiber optic current sensors using the Faraday Effect to modulate a polarization in the presence of a magnetic field, wherein the sensors are arranged outside conducting elements or inside conducting elements, including the umbilical.

As mentioned, the advantages of the subsea pump system of the present invention mainly relates to cost and reliability. For each sensor or each parameter to be measured at a specific location subsea, a rough estimate is that 0.1 to 1 million USD will be saved in capital cost before installation. The subsea pump system of the present invention can, for example, comprise several optical fiber sensors in each fiber, for example, at least three optical fiber sensors operatively arranged through the umbilical and to equipment subsea, and, for example, at least one redundant fiber or sensor for each parameter and location. The result is a very significant improvement in reliability. A significant simplification for installation will also be achieved since the installation subsea involves only one, optionally no, subsea wet connector matings, since all sensors are presinstalled and fusion spliced. Faster and simpler installation results in a significant cost reduction. The fiber optical sensors also have the advantage of not being affected by electromagnetism, which allows for measurements at locations where electronic sensors may not function.

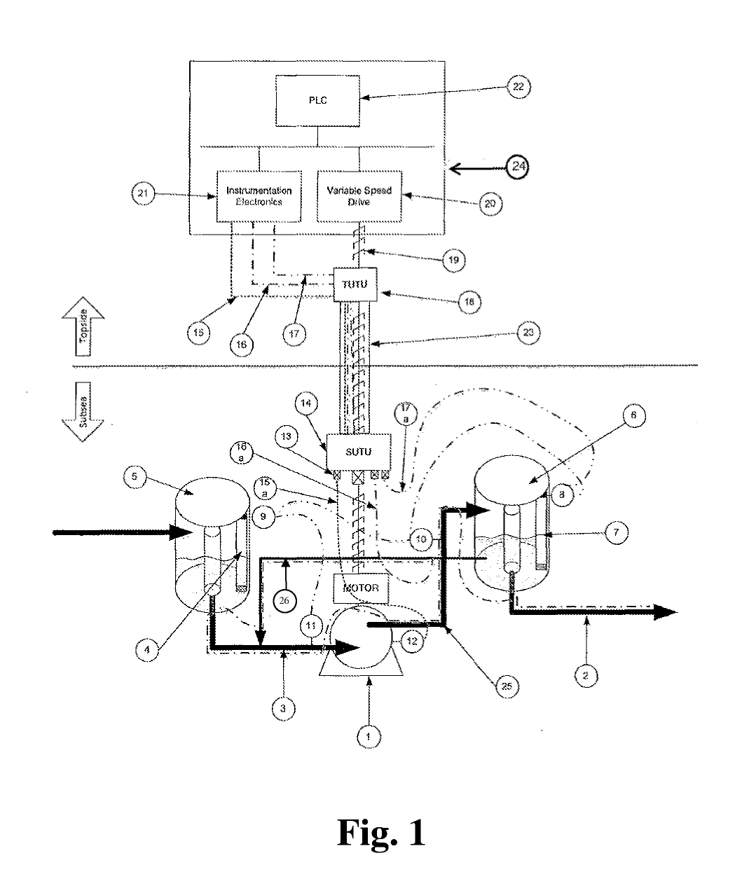

Reference is made to FIG. 1. A subsea pump (1) is connected to topside power and communication (24) system via an umbilical (23) containing power transmission cable (19) and optical fibers (15, 16, 17). The umbilical (23) is terminated at a topside umbilical termination unit (18) and subsea umbilical termination unit (14). The subsea umbilical termination unit (14) includes wet mateable connectors (13) for power cables and optical fibers. Subsea optical fibers (15a, 16a, 17a) forming the subsea instrumentation are connected to the subsea umbilical termination unit (14) through one or more wet mate connectors (13). In this embodiment: a first subsea optical fiber (15a) may be measuring vibration, for example, using distributed acoustic sensing; a second subsea optical fiber (16a) represents a fiber coupled to the pump station flow lines for distributed temperature measurement; and a third subsea optical fiber (17a) is a fiber with one or more Fabry Perot sensors for pressure measurements (10, 11) with the same fiber extended to measure strain or pressure (8, 9) for tank fluid density. More specifically, the system includes a fluid conditioning tank (5) which separates liquid and gas phases from a subsea well and provides an averaged gas volume fluid fraction at the pump input (3), achieved by having a perforated outlet pipe extending up into the tank volume. At the pump outlet (25) is a liquid conservation tank (6) which provides that a percentage of liquid is circulated back to the pump inlet (3), via a separate line (26) from a liquid filled part of the tank to upstream of the subsea pump (1). The fluid level in both the fluid conditioner tank (5) and in the liquid conservation tank (6) can be estimated by the use of a test cylinder, also termed a buoyancy element, of known density (4, 7), which is located inside the tanks, with either an optical strain or optical pressure gauge (8, 9) mechanically attached to a load bearing suspension structure between test cylinders (4, 7) and the tanks (5, 6), respectively. As the fluid level increases, the weight of the test cylinder (4, 7) will decrease due to the buoyancy from displacing fluid. This displacement is measured through the gauges (8, 9). A benefit of this approach is that it provides a measurement of net fluid density in the tank from which level may be interred by calculation. The net density measurement is also a useful input to the pump control algorithm as it is related to the density of fluid at the pump inlet.

Measurements such as those set forth above may be included on the same fiber or on additional fibers. In each case, the fiber used for measurement is extended through the umbilical (23) and the measurement is taken topside without the need for subsea electronics.

The subsea pump system and subsea pressure booster of the present invention may include every feature or step as here described or illustrated, in any operative combination, which operative combinations are embodiments of the present invention.

The present invention also provides a subsea pressure booster comprising a pump compartment or compressor compartment with impellers and diffusers and a motor compartment with a motor operatively coupled to rotate the impellers, and a lubrication arrangement for lubrication of the motor compartment bearings, seals and coil windings, wherein the subsea pressure booster comprises at least one optical fiber sensor arranged in the motor compartment or in a lubricant circuit part arranged from and to the motor compartment, for monitoring a lubricant flow rate, and, for example, all subsea sensors consist of optical fiber sensors and all electronics for monitoring and control consist of electronics arranged topsides. The flow rate of the lubricant, typically an oil or a water-glycol mixture, is a vital parameter for monitoring a subsea pressure booster in that it provides a direct monitored parameter providing an early warning if the lubricant flow rate drops or increases outside a due operation window, which parameter is not mentioned or implicit by the teaching of Smart Fibres or in US 2015/0110439 A1. The lubricant flow rate can, for example, be measured at the lubricant inlet to and lubricant outlet from a bearing or other component by using Fabry-Perot optical fiber pressure sensors which relate the lubricant pressure drop over the component to a lubricant flow rate and a motor speed. More specifically, a lubricant impeller or pump is driven directly by or is operatively coupled, typically with a 1 to 1 coupling, to the motor, meaning that the lubricant flow rate is directly related to motor speed. For a known or measured motor speed, the lubricant pressure drop over a component is then directly related to the lubricant flow rate. Fabry-Perot optical fiber sensors are alternatively arranged to measure strain or stress to a restriction in a lubricant inlet or outlet or both inlet and outlet, the measured strain or stress relating to lubricant flow rate. FBG vortex flow meters can be used, but are less feasible for measuring lubricant flow rate due to limitations with respect to vibrations, high lubricant viscosity at start up, and too small dimensions at the locations for measurements. The lubricant flow rate can, for example, be measured for each bearing of a motor shaft. Fabry-Perot optical fiber pressure or differential pressure sensors, and other fiber optical sensors or arrangements, are arranged in a single optical fiber or in several optical fibers. Pressure and temperature can, for example, also be measured, as well as vibration and other parameters, for example, with only optical fiber sensors subsea and electronics merely topsides.

The present invention is not limited to embodiments described herein; reference should be had to the appended claims.

What is claimed is:

1-9. (canceled)

10. A subsea pump system comprising:
a subsea pump;
a fluid conditioner tank arranged upstream of the subsea pump;
a liquid conservation tank arranged downstream of the subsea pump;
a line arranged to recirculate a liquid from the liquid conservation tank to upstream of the subsea pump;
an umbilical configured to provide a power, a monitoring, and a control;
a first buoyancy element suspended in the fluid conditioner tank;
a second buoyancy element suspended in the liquid conservation tank;
optical fiber sensors which are arranged at least to a suspension of the first buoyancy element in the fluid conditioner tank and to a suspension of the second buoyancy element in the liquid conservation tank; and
electronics.

11. The subsea pump system as recited in claim 10, further comprising:
subsea sensors,
wherein,
the subsea sensors consist of the optical fiber sensors, and
all electronics for the monitoring and the control consist of electronics which are arranged topsides.

12. The subsea pump system as recited in claim 10, further comprising a single wet mate connector which is arranged to connect the umbilical to the subsea pump, and the optical fiber sensors to the the fluid conditioner tank and to the liquid conservation tank.

13. The subsea pump system as recited in claim 10, wherein the fiber optical sensors are arranged in the umbilical to measure both a temperature and a strain of a dynamic loading of the umbilical.

14. The subsea pump system as recited in claim 10, further comprising at least one of a Fabry Perot optical fiber pressure sensor and a Fabry Perot optical fiber temperature sensor.

15. The subsea pump system as recited in claim 10, wherein the fiber optic sensors are configured to provide a liquid level monitoring using a differential pressure in the fluid conditioner tank and in the liquid conservation tank.

16. The subsea pump system as recited in claim 10, wherein the fiber optic sensors are provided as fiber optic Bragg grating sensor arrays attached to the suspension of the first buoyancy element in the fluid conditioner tank and to the suspension of the second buoyancy element in the liquid conservation tank.

17. The subsea pump system as recited in claim 10, further comprising:
a subsea equipment structure; and
subsea rotating equipment,
wherein,
the optical fiber sensors are provided as a fiber optic Bragg grating or as a Distributed Acoustic Sensing which is operatively arranged to the subsea equipment structure or to the subsea rotating equipment.

18. The subsea pump system as recited in claim 17, wherein,
the fiber optic sensors are provided as fiber optic current sensors using the Faraday Effect to modulate a polarization in the presence of a magnetic field, and
the fiber optic current sensors are arranged either outside of conducting elements or inside of conducting elements.

19. A subsea pressure booster comprising:
a pump compartment or a compressor compartment comprising impellers and diffusers;
a motor compartment comprising motor compartment bearings, seals and a motor which comprises coil windings, the motor being operatively coupled to rotate the impellers;
a lubrication arrangement for lubrication of the motor compartment bearings, the seals and the coil windings; and
at least one optical fiber sensor arranged in the motor compartment or in a lubricant circuit part arranged from and to the motor compartment, the at least one optical fiber sensor being arranged to monitor a lubricant flow rate.

20. The subsea pressure booster as recited in claim 19, further comprising:
subsea sensors; and
electronics for a monitoring and a control,
wherein,
all of the subsea sensors are provided as the at least one optical fiber sensor, and
all electronics for the monitoring and the control are arranged topsides.
